(19) United States
(12) Patent Application Publication
(10) Pub. No.: US 2026/0147116 A1
(43) Pub. Date: May 28, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Risako TSUJIMURA, Kanagawa (JP); Takahiro KAMAI, Kyoto (JP)

(21) Appl. No.: 19/448,825

(22) Filed: Jan. 14, 2026

Related U.S. Application Data
(63) Continuation of application No. PCT/JP2024/025291, filed on Jul. 12, 2024.
(60) Provisional application No. 63/529,445, filed on Jul. 28, 2023.

(30) Foreign Application Priority Data
Jan. 25, 2024 (JP) 2024-009614

(51) Int. Cl. G01S 15/04

(52) U.S. Cl. CPC G01S 15/04

(57) ABSTRACT

An information processing method is to be executed by a computer. The method includes acquiring information indicating a first reflected wave of ultrasound acquired by emitting the ultrasound into a space, calculating a feature based on a difference between a first signal and a second signal, the first signal being based on the reflected wave, the second signal being based on information indicating a second reflected wave acquired at a past time before the first reflected wave, and determining whether a person is present or absent in the space in accordance with the calculated feature.

### CROSS REFERENCE TO RELATED APPLICATIONS

This is a continuation application of PCT International Application No. PCT/JP2024/025291 filed on Jul. 12, 2024, designating the United States of America, which is based on and claims priority of U.S. Provisional Patent Application No. 63/529,445 filed on Jul. 28, 2023, and Japanese Patent Application No. 2024-009614 filed on Jan. 25, 2024. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

In recent years, devices with a sound speech function have come into widespread use in living spaces. Examples of such devices include smart speakers and home electrical appliances with a sound speech function. The devices are thought to determine the timing of speech according to the presence or absence of a person, thereby improving the effect of the speech. Patent Literature (PTL) 1 discloses a technique for detecting human movements by using Doppler shifts caused by emission of ultrasonic signals into an environment.

### CITATION LIST

### Patent Literature

PTL 1: U.S. Pat. No. 10,795,018

### SUMMARY

### Technical Problem

The technique disclosed in PTL 1, however, cannot detect the presence or absence of a person if there are no human movements, and therefore has difficulty in improving the effect of speech when a person is stationary. From the viewpoint of further improving the effect of speech, it is desirable to be able to detect the presence or absence of a person regardless of human movements.

In view of this, the present disclosure provides an information processing method, an information processing device, and a recording medium that are capable of detecting the presence or absence of a person regardless of whether there are human movements.

### Solution to Problem

An information processing method according to one aspect of the present disclosure is an information processing method that is executed by a computer. The information processing method includes acquiring information indicating a first reflected wave acquired by emitting ultrasound into a space, calculating a feature based on a difference between a first signal and a second signal, the first signal being based on the first reflected wave, the second signal being based on information indicating a second reflected wave acquired at a past time before the first reflected wave, and determining whether a person is present or absent in the space in accordance with the feature calculated.

An information processing device according to one aspect of the present disclosure includes an acquirer that acquires information indicating a first reflected wave of ultrasound, the first reflected wave being acquired by emitting the ultrasound into a space, a calculator that calculates a feature based on a difference between a first signal and a second signal, the first signal being based on the first reflected wave, the second signal being based on information indicating a second reflected wave acquired at a past time before the first reflected wave, and a determiner that determines, based on the feature calculated, whether a person is present or absent in the space.

A recording medium according to one aspect of the present disclosure is a non-transitory computer-readable recording medium having recorded thereon a program for causing a computer to execute the information processing method described above.

### Advantageous Effects

According to one aspect of the present disclosure, it is possible to realize an information processing method or the like that is capable of detecting the presence or absence of a person regardless of whether there are human movements.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing a functional configuration of an information processing system according to Embodiment 1.

FIG. 2 is a flowchart showing operations of the information processing system according to Embodiment 1.

FIG. 3 is a flowchart showing detailed operations performed in step S13 shown in FIG. 2.

FIG. 4 is a diagram showing one example of various waveforms according to Embodiment 1.

FIG. 5 is a flowchart corresponding to step S13 shown in FIG. 2 and showing operations of an information processing device according to Variation 1 of Embodiment 1.

FIG. 6 is a diagram showing one example of various waveforms according to Variation 1 of Embodiment 1.

FIG. 7 is a flowchart corresponding to step S13 shown in FIG. 2 and showing operations of an information processing device according to Variation 2 of Embodiment 1.

FIG. 8 is a flowchart corresponding to step S13 shown in FIG. 2 and showing operations of an information processing device according to Variation 3 of Embodiment 1.

FIG. 9 is a diagram showing one example of various waveforms according to Variation 3 of Embodiment 1.

FIG. 10 is a block diagram showing a functional configuration for estimation of an impulse response by an adaptive filter according to Variation 3 of Embodiment 1.

FIG. 11 is a flowchart corresponding to step S13 shown in FIG. 2 and showing operations of an information processing device according to Variation 4 of Embodiment 1.

FIG. 12 is a flowchart showing detailed operations performed in step S162 shown in FIG. 11.

FIG. 13 is a flowchart showing detailed operations performed in step S163 shown in FIG. 11.

FIG. 14 is a diagram showing one example of various waveforms according to Variation 4 of Embodiment 1.

FIG. 15 is a flowchart corresponding to step S13 shown in FIG. 2 and showing operations of an information processing device according to Variation 5 of Embodiment 1.

FIG. 16 is a block diagram showing a functional configuration of an information processing system according to Embodiment 2.

FIG. 17 is a flowchart showing operations of the information processing system according to Embodiment 2.

### DESCRIPTION OF EMBODIMENTS

An information processing method according to a first aspect of the present disclosure is an information processing method that is executed by a computer. The information processing method includes acquiring information indicating a first reflected wave acquired by emitting ultrasound into a space, calculating a feature based on a difference between a first signal and a second signal, the first signal being based on the first reflected wave, the second signal being based on information indicating a second reflected wave acquired at a past time before the first reflected wave, and determining whether a person is present or absent in the space in accordance with the feature calculated.

This method uses the feature based on the difference from past data on the reflected wave (the second reflected wave). Thus, the latest movement of a person can be detected as a difference even if, for example, the person is not moving at the present time. That is, it is possible to detect the presence of a person even if the person is not moving at the present time. Accordingly, with the information processing method, it is possible to detect the presence or absence of a person regardless of whether there are human movements at the present time.

An information processing method according to a second aspect is, for example, the information processing method according to the first aspect. The first signal may include the first reflected wave, the second signal includes the second reflected wave, and the feature may be a value based on a first standard deviation of an amplitude of a differential signal between the first reflected wave and the second reflected wave.

With this method, the feature that represents features of the amplitudes of the reflected waves can be obtained by calculating the dispersion of the reflected waves. Since the amplitudes of the reflected waves can vary according to whether there are human movements, using this feature allows detecting the presence or absence of a person regardless of whether there are human movements.

An information processing method according to a third aspect is, for example, the information processing method according to the first aspect. The information processing method may further includes acquiring a first direct wave of the ultrasound. The first signal may include a first convolutional signal obtained by convolution of the first reflected wave and the first direct wave, the second signal may include a second convolutional signal obtained by convolution of a second direct wave and the second reflected wave acquired at a past time before the first reflected wave, and the feature may be a value based on a first standard deviation of an amplitude of a differential signal between the first convolutional signal and the second convolutional signal.

With this method, the direct waves and the reflected waves are associated by convolution. Thus, even if emitted sound is unstable, it is possible to reduce influences exerted during the calculation of the feature.

An information processing method according to a fourth aspect is, for example, the information processing method according to the first aspect. The information processing method may further includes acquiring a direct wave of the ultrasound, generating a direct-wave signal and a reflected-wave signal, the direct-wave signal being generated by substituting an amplitude of the first reflected wave in a received signal with zero, the reflected-wave signal being generated by substituting an amplitude of the direct wave in the received signal with zero, the received signal including the direct wave and the first reflected wave, and estimating a first impulse response via an adaptive filter in accordance with the direct-wave signal and the reflected-wave signal. The first signal may include the first impulse response, and the second signal may include a second impulse response acquired at a past time before the first impulse response.

With this method, a period of the estimation of the impulse response becomes a sampling period (a period of determination of the presence or absence). Thus, the sampling period can be made shorter than a period of transmission of a sound source. This improves trackability to slight changes in the state a space and accordingly improves robustness against disturbances.

An information processing method according to a fifth aspect is, for example, the information processing method according to the first aspect, in which the first signal may include a signal that indicates a change over time in an amplitude of the first reflected wave, and the second signal may include a signal that indicates a change over time in an amplitude of the second reflected wave, the second reflected wave being acquired at a past time before the first reflected wave.

With this method, the use of the signals (e.g., envelopes) indicating changes in amplitude over time allows attention to be focused on only the amplitudes of the reflected waves. This eliminates the influence of phase shifts of the reflected waves caused by disturbances such as airflow and accordingly improves robustness against the disturbances.

An information processing method according to a sixth aspect is, for example, the information processing method according to the second or third aspect, in which the first signal may include a first envelope signal that indicates a change over time in an amplitude of the first reflected wave, the second signal may include a second envelope signal that indicates a change over time in an amplitude of the second reflected wave, the second reflected wave being acquired at a past time before the first reflected wave, and the feature may be a value calculated by computing a value based on the first standard deviation and a maximum value of an amplitude of a differential signal between the first envelope signal and the second envelope signal.

With this method, two features including the maximum value and the first standard deviation are used to calculate the feature for use in determining the presence or absence of a person. The use of the two features allows determining the presence or absence of a person more accurately than in the case of using only one feature.

An information processing method according to a seventh aspect is, for example, the information processing method according to any one of the first to sixth aspects, in which the second reflected wave may have an average waveform of reflected waves received at a plurality of past times.

With this method, even if noise is included in the latest reflected waves, the use of the average waveform allows accurate determination of the presence or absence of a person.

An information processing method according to an eighth aspect is, for example, the information processing method according to the second or third aspect. The information processing method may further includes acquiring one or more second standard deviations calculated at one or more past times before the first standard deviation. The feature may be a value obtained by a smoothing process performed on the first standard deviation and the one or more second standard deviations.

With this method, minimal variable components can be removed. Accordingly, it is possible to accurately determine the presence or absence of a person.

An information processing method according to a ninth aspect is, for example, the information processing method according to the eighth aspect, in which the smoothing process may include a moving average process.

With this method, a moving average can be used to remove minimal variable components included in the feature.

An information processing method according to a tenth aspect is, for example, the information processing method according to the eighth aspect, in which the smoothing process may include a peak hold process for storing a maximum value of the one or more second standard deviations acquired during a predetermined period of time, and the feature may be a value based on the first standard deviation and the maximum value stored in the peak hold process.

With this method, a peak value of the feature caused by the immediately preceding human movement in the past data can be maintained while being attenuated. Thus, a higher feature value can be held even if there is only a little human movement. That is, even if there is only a little human movement, it is possible to determine the presence or absence of a person with higher accuracy.

An information processing method according to an eleventh aspect is, for example, the information processing method according to any one of the first to tenth aspects, in which the ultrasound may be emitted periodically.

With this method, the ultrasound is emitted periodically. This facilitates the acquisition of, for example, a reflected wave at the present time and a reflected wave at a past time (a reflected wave corresponding to a past signal emitted periodically).

An information processing method according to a twelfth aspect is, for example, the information processing method according to any one of the first to eleventh aspects, in which the ultrasound may include a burst wave.

With this method, using the burst wave facilitates the acquisition of a reflected wave at the present time and a reflected wave at a past time (a reflected wave corresponding to a past signal emitted periodically).

An information processing method according to a thirteenth aspect is, for example, the information processing method according to the twelfth aspect, in which the burst wave may include a plurality of frequency components.

With this method, using reflected waves with respect to signals of the plurality of frequencies reduces the influence of noise such as noise of a specific frequency or noise accompanying environmental changes such as temperature, humidity, or airflow.

An information processing method according to a fourteenth aspect is, for example, the information processing method according to any one of the first to thirteenth aspects, in which the ultrasound may include a chirp signal.

With this method, using reflected wave with respect to chirp signals of a plurality of frequencies reduces the influence of noise such as noise of a specific frequency or noise accompanying environmental changes such as temperature, humidity, or airflow.

An information processing method according to a fifteenth aspect is, for example, the information processing method according to any one of the first to fourteenth aspects, in which a person may be determined to be present in the space when the feature is greater than or equal to a predetermined value, and a person may be determined to be absent in the space when the feature is less than the predetermined value.

With this method, the presence or absence of a person can be determined by a simple determination method using the predetermined value. This reduces the throughput of an information processing device that executes the information processing method.

An information processing method according to a sixteenth aspect is, for example, the information processing method according to any one of the first to fourteenth aspects. The information processing method may further include acquiring, by inputting the feature to a machine learning model, a result of inference as to whether a person is present or absent in the space.

With this method, the presence or absence of a person can be determined using the machine learning model.

An information processing method according to a seventeenth aspect is, for example, the information processing method according to the sixteenth aspect. The information processing method may further include acquiring a plurality of features and a plurality of determination results as to whether a person is present or absent, and training the machine learning model by using the plurality of features acquired as input information and using the plurality of determination results as correct data.

With this method, it is possible to construct the machine learning model.

An information processing device according to one aspect of the present disclosure includes an acquirer that acquires information indicating a first reflected wave of ultrasound, the first reflected wave being acquired by emitting the ultrasound into a space, a calculator that calculates a feature based on a difference between a first signal and a second signal, the first signal being based on the first reflected wave, the second signal being based on information indicating a second reflected wave acquired at a past time before the first reflected wave, and a determiner that determines, based on the feature calculated, whether a person is present or absent in the space. A recording medium according to one aspect of the present disclosure is a non-transitory computer-readable recording medium having recorded thereon a program for causing a computer to execute the information processing method described above.

This information processing device and this recording medium can achieve similar effects to those of the information processing method described above.

These general and specific aspects may be implemented using a system, a method, an integrated circuit, a computer program, or a computer-readable recording medium such as a CD-ROM, or any combination of systems, methods, integrated circuits, computer programs, or computer-readable recording media. The program may be stored in advance in the recording medium, or may be supplied to the recording medium via a wide-area communication network such as the Internet.

Hereinafter, exemplary embodiments are described in greater detail with reference to the accompanying drawings.

Each of the exemplary embodiments described below shows a generic or specific example. The numerical values, shapes, materials, elements, the arrangement and connection of the elements, steps, the processing order of the steps, etc., shown in the following exemplary embodiments are mere examples, and therefore do not limit the scope of the present disclosure. Among the elements in the following embodiments, those not recited in any one of the independent claims are described as optional elements.

Each of the accompanying drawings is a schematic diagram and does not always strictly follow the actual configuration. Therefore, for example, scale reduction, etc., in each drawing is not necessarily the same. In each drawing, identical constituent members are given the same reference numerals, and redundant descriptions thereof shall be omitted or simplified.

In the specification of the present disclosure, terms that indicate the relationship of elements such as being the same, numerical values, and the ranges of numerical values are not the expressions that represent only precise meaning, but are also the expressions that mean the inclusion of substantially equivalent ranges such as differences within the range of several percent (or about 10%).

In the specification of the present disclosure, ordinal numbers such as “first” and “second” do not refer to the number or sequence of constituent elements, unless otherwise specified, and are used to avoid confusion with the same type of constituent elements and to distinguish such constituent elements from one another.

### Embodiment 1

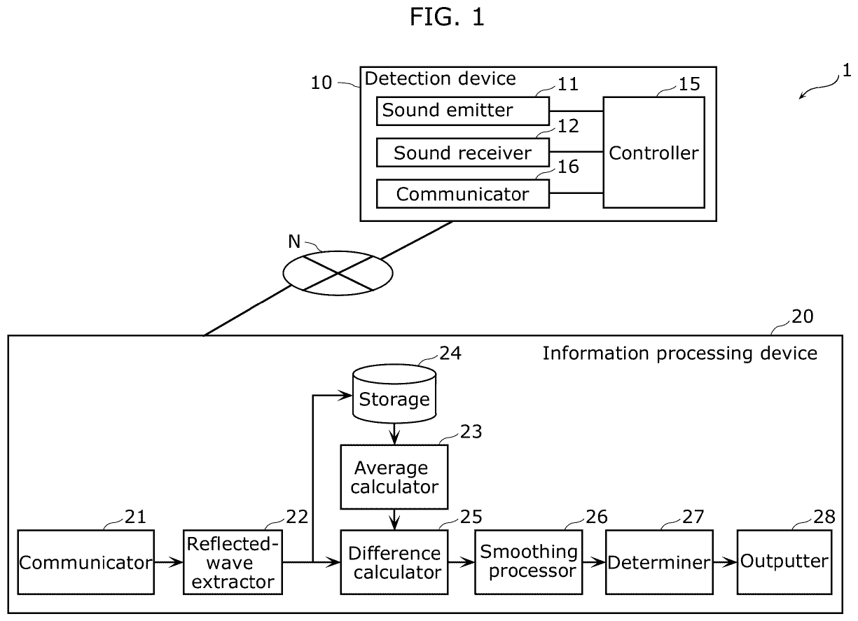

Hereinafter, an information processing system that includes an information processing device according to the present embodiment is described with reference to FIGS. 1 to 4.

### 1-1. Configuration of Information Processing System

First, a configuration of an information processing system according to the present embodiment is described with reference to FIG. 1. FIG. 1 is a block diagram showing a functional configuration of information processing system 1 according to the present embodiment.

Information processing system 1 is a detection system for detecting the presence or absence of a person (whether or not any person is present) in a predetermined space and, for example, is used to detect a person in a sound speech system or the like that includes a device with a sound speech function. In the sound speech system, after sound corresponding the contents of speech is produced, the sound is played from a loudspeaker or the like when information processing device 20 has detected any person. Although described in detail later, information processing device 20 is capable of detecting the presence of a person even if the person is not moving at the present time, and is accordingly capable of detecting the presence or absence of a person with greater accuracy. This allows the sound speech system to determine the timing of speech with greater accuracy and to further improve the effect of the speech.

The predetermined space may, for example, be a space where the sound speech system (e.g., a loudspeaker) is installed. The predetermined space may be an indoor space or an outdoor space.

As shown in FIG. 1, information processing system 1 includes detection device 10 and information processing device 20.

Detection device 10 is a device that produces and receives ultrasound for use in detecting a person who is present in the predetermined space. Detection device 10 is configured to be capable of emitting ultrasound into the predetermined space and receiving reflected sound reflected from a person. Detection device 10 may be realized as part of the sound speech system. Detection device 10 may also be a stationary device or a portable device having portability. Detection device 10 is communicably connected to information processing device 20 via network N and transmits information acquired by detection device 10 to information processing device 20.

Detection device 10 includes sound emitter 11, sound receiver 12, controller 15, and communicator 16.

Sound emitter 11 is, for example, an ultrasound emitter that includes a loudspeaker or the like and emits ultrasound into the predetermined space. For example, sound emitter 11 may emit ultrasound periodically. For example, sound emitter 11 may emit burst waves having frequences outside the audible range (e.g., higher than or equal to 20 kHz) in a predetermined cycle. The cycle is, for example, 25 ms, but not limited thereto. Alternatively, sound emitter 11 may emit ultrasound with a single frequency, or may emit ultrasound with a plurality of frequencies synchronously and/or asynchronously. The burst waves may include, for example, a plurality of frequency components. The sound emitted from sound emitter 11 is reflected on a person and collected as reflected sound by sound receiver 12.

The burst waves are signals emitted at predetermined time intervals. The burst waves are such that a domain where no signals exist and a domain where a signal exists are repeated in a time domain. Using the burst waves brings about the advantage of being capable of separating direct waves and reflected waves. Note that sound emitter 11 is not limited to emitting the burst waves as long as being capable of emitting ultrasound periodically and, for example, may emit chirp signals whose frequencies increase or decrease over time, instead of the burst waves.

Sound receiver 12 is, for example, a receiver that includes a 1-channel (ch.) or more microphone and receives reflected waves of the ultrasound emitted from sound emitter 11. Sound receiver 12 also receives direct waves of the ultrasound emitted from sound emitter 11. The direct waves are signals obtained when the ultrasound emitted from sound emitter 11 has arrived directly at sound receiver 12, whereas the reflected waves are signals received at sound receiver 12 after the arrival of the direct waves. The reflected waves are signals obtained when the ultrasound emitted from sound emitter 11 is reflected on a target object such as a person.

Controller 15 is a processor that controls sound emitter 11, sound receiver 12, and communicator 16. Controller 15 transmits information about a sound-emitting signal and information about a sound-receiving signal to information processing device 20 via communicator 16, the sound-emitting signal being a signal for allowing sound emitter 11 to emit sound, the sound-receiving signal being based on the reflected sound acquired by sound receiver 12.

Communicator 16 is a communication module that is communicably connected to information processing device 20 via network N. For example, communicator 16 is wirelessly connected to network N.

Information processing device 20 is a device for detecting the presence or absence of a person in a predetermined space in accordance with signals received from detection device 10. Specifically, information processing device 20 is a device for detecting the presence or absence of a person in a predetermined space in accordance with information based on a sound-receiving signal obtained when sound receiver 12 such as a microphone has received a reflected wave acquired by sound emitter 11 such as a loudspeaker emitting ultrasound into a space.

Information processing device 20 includes, as its functional configuration, communicator 21, reflected-wave extractor 22, average calculator 23, storage 24, difference calculator 25, smoothing processor 26, determiner 27, and outputter 28. Information processing device 20 is realized by, for example, nonvolatile memory that stores programs, volatile memory serving as a temporal storage area for program execution, input/output ports, a communication interface, and a processor that executes programs. Information processing device 20 is realized by, for example, a server device. Note that information processing device 20 may be a desktop personal computer (PC), a mobile terminal such as a portable PC, a smartphone, or a tablet, or a dedicated computer.

Communicator 21 is a communication module and is communicably connected to detection device 10 via network N. Communicator 21 acquires information output from detection device 10 and outputs the acquired information to reflected-wave extractor 22.

Reflected-wave extractor 22 includes, for example, a band-pass filter and serves to eliminate unnecessary frequencies from a signal received by sound receiver 12 and to extract a signal in a reflected-wave section (reflected-wave data). The extracted reflected-wave data is stored in storage 24. The unnecessary frequencies refer to frequencies other than the frequencies emitted by sound emitter 11. The extracted reflected wave is one example of a first signal.

Note that reflected-wave extractor 22 may process only a specific frequency such as the frequency of an emitted signal in a frequency domain. In this case, reflected-wave extractor 22 does not need to include the band-pass filter.

Average calculator 23 is a processing unit that calculates an average of reflected-wave data items over a predetermined number of seconds or a predetermined number of reflected-wave data items, the reflected-wave data items being stored in storage 24. Each reflected-wave data item is represented by the horizontal axis indicating time and the vertical axis indicating the amplitude or a numerical value indicating the normalized amplitude, and average calculator 23 calculates, for each one time period, an average value of the amplitudes or the numerical values indicating the normalized amplitudes over the one time period. That is, average calculator 23 calculates time-series data of each average value of amplitudes or numerical values indicating normalized amplitudes over one time period.

Note that average calculator 23 is not limited to calculating the average values, and may calculate other values such as median values or mode values. The reflected-wave data stored in storage 24 is one example of a second signal based on a second reflected wave at a past time before a first reflected wave.

Note that average calculator 23 may process only a specific frequency such as the frequency of the emitted signal in a frequency domain. In this case, reflected-wave extractor 22 does not need to include the band-pass filter.

Alternatively, average calculator 23 may be omitted in the case where difference calculator 25 calculates a difference by using only one past reflected-wave data item (e.g., the latest reflected-wave data item).

Storage 24 stores past reflected-wave data and a standard deviation of past differential signals (one example of a feature). For example, storage 24 may store, as the past reflected-wave data items, only reflected-wave data items over a predetermined number of seconds or a predetermined number of reflected-wave data items. In other words, storage 24 may delete past reflected-wave data items at past times before the predetermined number of seconds, or old reflected-wave data items when the number of reflected-wave data items exceeds the predetermined number. Note that storage 24 may store an average of the past reflected-wave data items calculated by average calculator 23.

Alternatively, for example, storage 24 may store, as the standard deviation of past differential signals, only a standard deviation of differential signals over a predetermined number of seconds, or a standard deviation of a predetermined number of differential signals. In other words, storage 24 may delete a standard deviation of differential signals at past times before the predetermined number of seconds, or a standard deviation of old differential signals when the number of differential signals exceeds the predetermined number. Storage 24 is realized as, for example, semiconductor memory or the like, but not limited thereto.

Difference calculator 25 is a processing unit that calculates a difference between the extracted reflected wave and an average of past reflected-wave data items. Difference calculator 25 acquires a difference between the waveform of the received reflected wave and an average waveform of the past reflected-wave data items. Difference calculator 25 calculates, for each one time period, a difference in amplitude or the numerical value indicating the normalized amplitude over the one time period.

The extracted reflected wave and the past reflected-wave data further include data on immovable substances existing in the space, such as a desk. A differential signal (differential waveform) generated by obtaining an average difference between the extracted reflected wave and the past reflected-wave data can be a signal obtained by reducing the influence of the immovable substances from the extracted reflected wave. Using this differential waveform improves detection sensitivity to moving substances.

Difference calculator 25 also calculates a standard deviation of the amplitudes in the differential signal. The standard deviation is a scalar value.

Note that difference calculator 25 may process only a specific frequency such as the frequency of the emitted signal in a frequency domain. In this case, reflected-wave extractor 22 does not need to include the band-pass filter.

Smoothing processor 26 is a processing unit that executes an averaging process for removing minimal variable components. In the present embodiment, smoothing processor 26 executes a moving average process for calculating a moving average of a predetermined number of samples. Smoothing processor 26 calculates a moving average of the standard deviation calculated by difference calculator 25 and the past standard deviation stored in storage 24 as the feature for use in detecting the presence or absence of a person. Note that smoothing processor 26 is not a required configuration. That is, the smoothing process may not be executed.

Note that smoothing processor 26 may process only a specific frequency such as the frequency of the emitted signal in a frequency domain. In this case, reflected-wave extractor 22 does not need to include the band-pass filter.

Determiner 27 is a processing unit that determines whether or not any person is present in the space, in accordance with the value of the feature that is output from smoothing processor 26. In the present embodiment, determiner 27 determines whether or not any person is present in the space, on the basis of the feature and a preset threshold value.

Outputter 28 outputs the result of determination by determiner 27. For example, outputter 28 may transmit the determination result to the sound speech system. Outputter 28 is configured to include, for example, a communication interface.

### 1-2. Operations of Information Processing System

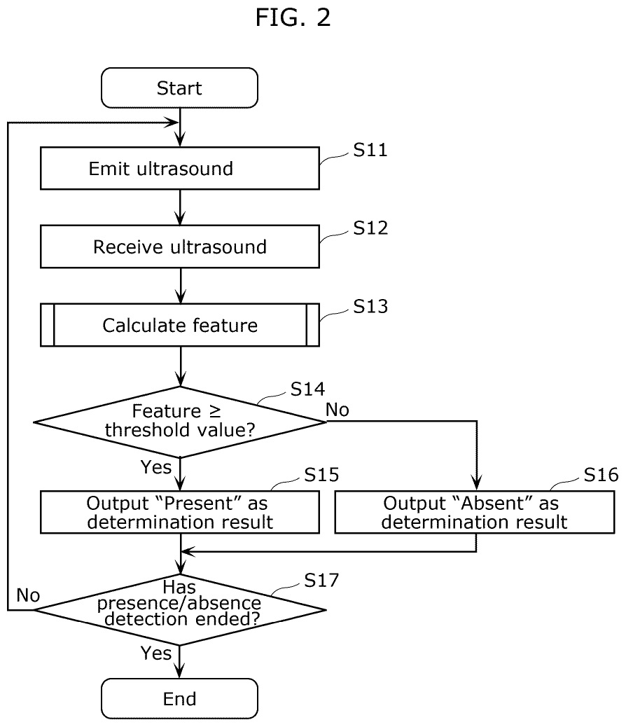

Next, operations of information processing system 1 configured as described above are described with reference to FIGS. 2 to 4. FIG. 2 is a flowchart showing the operations of information processing system 1 (information processing method) according to the present embodiment. Steps S11 and S12 shown in FIG. 2 are operations that are executed by detection device 10, and steps S13 to S17 are operations that are executed by information processing device 20.

As shown in FIG. 2, first, sound emitter 11 emits ultrasound (S11), and sound receiver 12 receives the ultrasound (S12). For example, sound receiver 12 receives direct waves and reflected waves. Note that sound receiver 12 may receive reflected waves that correspond at least to a target range for detecting a person.

Controller 15 transmits information about the ultrasound emitted in step S11 and information about the ultrasound received in step S12 to information processing device 20 via communicator 16. Then, information processing device 20 acquires the information transmitted from detection device 10 via communicator 21. Note that the information about the received ultrasound includes information indicating the reflected wave (waveform data on the reflected wave). The information about the received ultrasound is one example of information indicating the first reflected wave. Communicator 21 functions as an acquirer that acquires the information indicating the first reflected wave via communication.

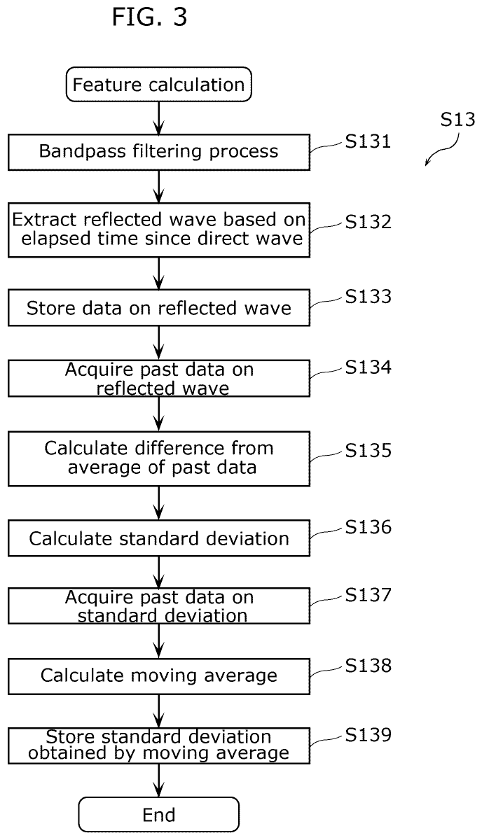

Then, information processing device 20 calculate a feature based on at least the reflected wave (S13). Step S13 will be described later with reference to FIG. 3.

Then, determiner 27 determines whether the feature is greater than or equal to a threshold value (S14). When the feature is greater than or equal to the threshold value (Yes in S14), determiner 27 determines that there is someone in the space. When the feature is less than the threshold value (No in S14), determiner 27 determines that there is no one in the space.

Then, when determiner 27 has determined that the feature is greater than or equal to the threshold value, outputter 28 outputs a determination result of “Present” that indicates the presence of someone in the space (e.g., a target detection range in the space) (S15), and when determiner 27 has determined that the feature is less than the threshold value, outputter 28 outputs a determination result of “Absent” that indicates the presence of no one in the space (e.g., the target detection range in the space) (S16).

Then, information processing device 20 determines whether the detection of the presence or absence has ended (S17). When it is determined that the detection has ended (Yes in S17), the process ends, and when it is determined that the detection has not yet ended (No in S17), the process returns to step S11 and continues to be executed. When the determination result in step S17 is No, information processing device 20 transmits information indicating that steps S11 and S12 are to be re-executed, to detection device 10.

There are no particular limitations on the timing of execution of the process shown in FIG. 2, and the process may be executed with predetermined timing, or may be executed at regular intervals.

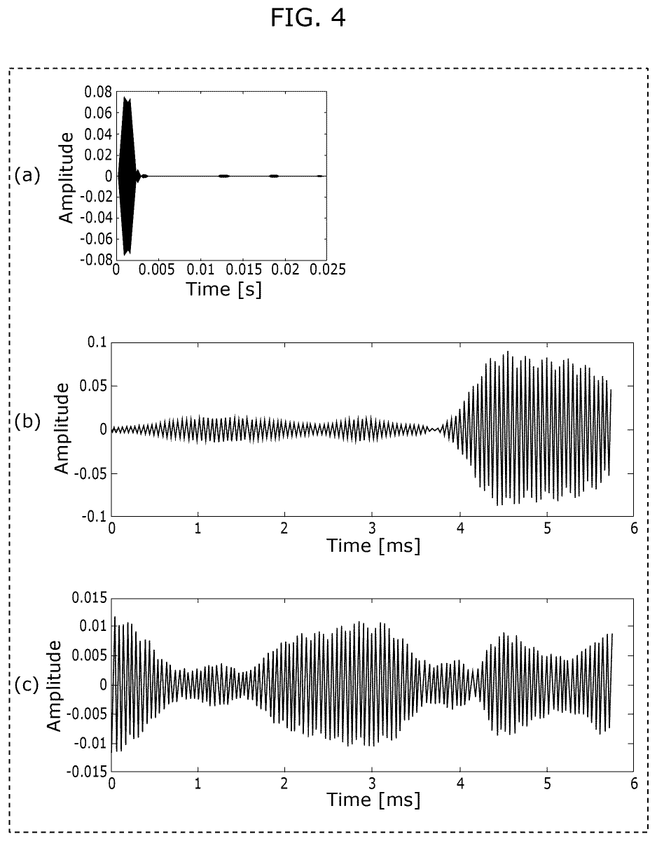

FIG. 3 is a flowchart showing detailed operations (information processing method) performed in step S13 shown in FIG. 2. FIG. 4 is a diagram showing one example of various waveforms according to the present embodiment. In FIG. 4, the horizontal axis indicates time, and the vertical axis indicates intensity.

As shown in FIG. 3, reflected-wave extractor 22 performs a band-pass filtering process on the signal received by sound receiver 12 (S131). Reflected-wave extractor 22 extracts a signal of the frequency of the ultrasound emitted from sound emitter 11 from the signal received by sound receiver 12. For example, a signal shown in (a) in FIG. 4 is extracted. In FIG. 4, (a) shows a signal that includes a large-amplitude direct wave (e.g., before 0.0025 seconds(s)) and a small-amplitude reflected wave (e.g., after 0.0025 s onward).

Referring back to FIG. 3, reflected-wave extractor 22 then extracts the reflected wave from the signal that has undergone the band-pass filtering process, based on the elapsed time since the direct wave (S132). The result of a multiplication of the difference in arrival time between the direct wave and the reflected wave, i.e., an arrival time interval, by the velocity of sound can be translated as the distance from information processing device 20 (e.g., sound emitter 11) to a reflector. For example, in the case where there is a set target detection range of detecting the presence or absence of a person, the elapsed time according to the target detection range can be calculated. The arrival time of the direct wave can be acquired in advance from, for example, the positional relationship between sound emitter 11 and sound receiver 12. Thus, reflected-wave extractor 22 extracts a signal within the target detection range from the signal shown in (a) in FIG. 4, based on the elapsed time since the direct wave. In (a) in FIG. 4, 0 s is the point in time when sound emitter 11 emitted ultrasound.

The target detection range can be set arbitrarily by changing the elapsed time. For example, a specific distance or a specific distance section (a section for analysis of the presence or absence of a person) may be selected as the target for analysis from information processing device 20.

In FIG. 4, (b) shows the signal within the target detection range, extracted by reflected-wave extractor 22. In (b) in FIG. 4, 0 milliseconds (ms) is the time corresponding to the closest distance within the target detection range. The amplitude in (b) in FIG. 4 is the value normalized by using a maximum value of the amplitude of the direct wave shown in (a) in FIG. 4 as 1. In (b) in FIG. 4, the amplitude is relatively small until 4 ms and becomes larger after 4 ms onward.

Referring back to FIG. 3, reflected-wave extractor 22 then stores data on the reflected wave shown in (b) in FIG. 4 in storage 24 (S133). The stored data on the reflected wave serves as past data on the reflected wave and is used the next time when the process shown in FIG. 3 is executed.

Then, average calculator 23 acquires the past data on the reflected wave from storage 24 (S134) and calculates an average of the past data on the reflected wave. The past data on the reflected wave is one example of a second reflected wave. The term “past” as used herein refers to past times before the reflected wave is acquired in step S12 and includes, for example, a time when the process shown in FIG. 2 was executed the last time or before the last time.

Then, difference calculator 25 calculates a difference between the reflected wave shown in (b) in FIG. 4 and the average of the past data (S135). The reflected wave shown in (b) in FIG. 4 is one example of the first signal, and the average of the past data is one example of the second signal based on the information indicating the second reflected wave.

In FIG. 4, (c) shows a signal (differential signal) indicating the difference between the reflected wave shown in (b) in FIG. 4 and the average of the past data. Here, the amplitude of the differential signal shown in (c) in FIG. 4 decreases greatly from 4 ms onward from the reflected wave shown in (b) in FIG. 4. This is the result of reducing the influence of an immovable substance existing in the space. That is, an immovable substance exists at positions corresponding to times after 4 ms onward in the space, and the reflected wave shown in (b) in FIG. 4 includes a reflected wave received from the immovable substance, but the differential signal shown in (c) in FIG. 4 removes the reflected wave from the immovable substance by obtaining a difference from the past data.

Referring back to FIG. 3, difference calculator 25 then calculates a standard deviation of the differential signal (S136). The standard deviation as used herein is a standard deviation in a time-axis direction and can be said as a standard deviation of the amplitude corresponding to the target detection range. Since the reflected wave contains the state of the space including a person, the state of the reflector is also reflected on the amplitude of the reflected wave. By calculating the standard deviation (dispersion) of the reflected wave, it is possible to acquire a feature that represents a feature of the amplitude of the reflected wave. Difference calculator 25 stores the calculated standard deviation in storage 24. The standard deviation is a value indicating fluctuations in amplitude and is a scalar value. The standard deviation, i.e., the feature, may be a dimensionless quantity. The standard deviation calculated in step S136 is one example of a first standard deviation.

Then, smoothing processor 26 acquires past data on the standard deviation from storage 24 (S137) and calculates a moving average of the standard deviation calculated in step S136 and the past data on the standard deviation (S138). The value of the moving average of the standard deviation calculated in step S138 is used as the feature in step S14 onward shown in FIG. 2. The past data on the standard deviation is one example of one or more second standard deviations calculated at past times before the first standard deviation.

Then, smoothing processor 26 stores the standard deviation that has undergone the moving average in storage 24 (S139). The stored standard deviation serves as the past data on the standard deviation and used the next time when the process shown in FIG. 3 is executed.

As described above, using the differential signal allows information processing device 20 to detect a person regardless of whether there are human movements because, for example, the amplitude of the differential signal increases when there were human movements in the past, but there are no human movements at the present time.

### Variation 1 of Embodiment 1

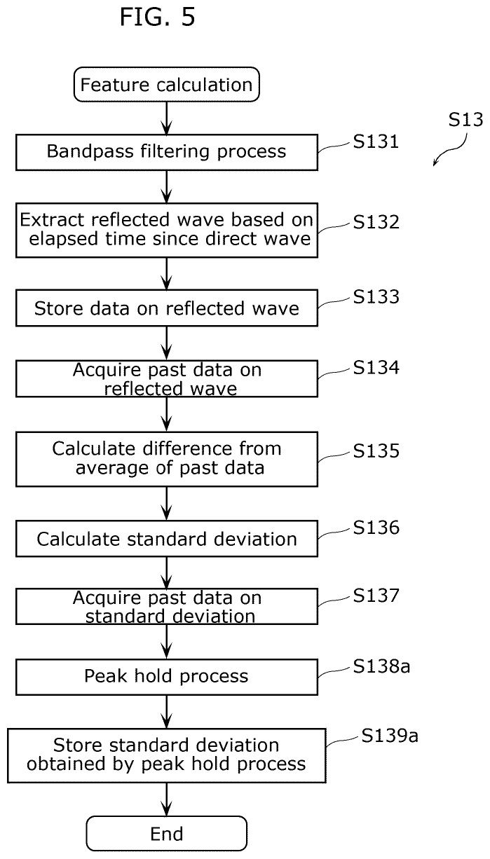

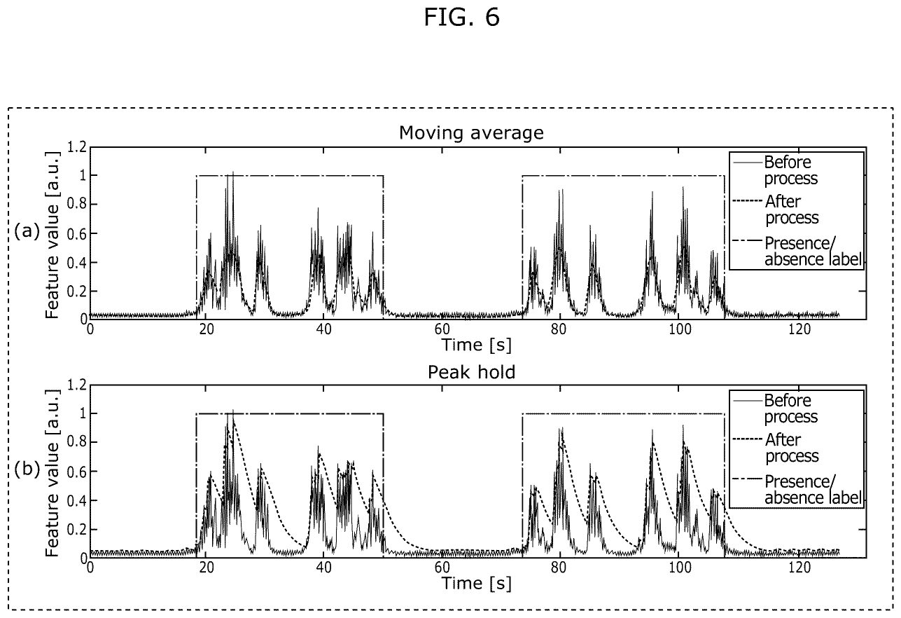

Hereinafter, an information processing system according to a variation of the present embodiment is described with reference to FIGS. 5 and 6. Each of variations described below focuses on differences from Embodiment 1, and descriptions of contents that are identical or similar to those described in Embodiment 1 may be omitted or simplified. A configuration of the information processing system according to each variation described below is similar to that of information processing system 1 according to Embodiment 1, and is described using reference signs used for information processing system 1 according to Embodiment 1.

FIG. 5 is a flowchart corresponding to step S13 shown in FIG. 2 and showing operations of information processing device 20 (information processing method) according to the present variation. The present variation describes information processing device 20 capable of detecting a person even when there is only a little human movement. Specifically, an example is described in which a peak hold process is used as the smoothing process.

As shown in FIG. 5, smoothing processor 26 acquires the past data on the standard deviation (S137) and executes a peak hold process (S138a). The peak hold process is a process of storing a maximum value of standard deviations acquired during a predetermined period of time.

Smoothing processor 26 executes the peak hold process in accordance with Expressions 1 to 3 below.

$$Ph = ( 1 - af ) \times x [ n ] + af \times Ph ( x [ n ] > Ph ) \qquad Expression 1$$

$$Ph = ( 1 - as ) \times x [ n ] + as \times Ph ( otherwise ) \qquad Expression 2$$

$$xy [ n ] = Ph \qquad Expression 3$$

Ph is the peak hold value, x is the original signal, xy is the output signal from the peak hold process, af is a rising coefficient for peak hold, as is an attenuation coefficient for peak hold, and n represents the time index. The time index is a numerical value indicating what number of data in the data row. Expressions 1 to 3 are stored in advance in storage 24.

Smoothing processor 26 sequentially updates the peak hold value in accordance with Expressions 1 to 3. When the current value (the amplitude of the differential signal) is greater than the peak hold value, smoothing processor 26 updates the peak hold value by multiplying it by rising coefficient af. When the current value is less than or equal to the peak hold value, smoothing processor 26 updates the peak hold value by multiplying it by attenuation coefficient as.

Smoothing processor 26 also stores the standard deviation that has undergone the peak hold process in storage 24 (S139a).

FIG. 6 is a diagram showing one example of various waveforms according to the present variation. In FIG. 6, the horizontal axis indicates time, and the vertical axis indicates the amplitude of the differential signal (Feature value [a.u.] in FIG. 6). In FIG. 6, (a) shows the waveform when the moving average process is performed as the smoothing process (the waveform after the process shown in (a) in FIG. 6), and (b) shows the waveform when the peak hold process is performed as the smoothing process (the waveform after the process shown in (b) in FIG. 6). Note that “Before process” (solid line) and “Presence/absence label” (alternate short and long dashed lines) shown in (a) and (b) in FIG. 6 are common. Moreover, “Before process” indicates the differential signal before the smoothing process, “After process” indicates the differential signal after the smoothing process, and “Presence/absence label” indicates the result of determining the presence or absence of a person by determiner 27.

As indicated by the waveforms after the process shown in (a) and (b) in FIG. 6, using the peak hold process as the smoothing process allows the peak value of the feature provided by the immediately preceding human movement to be kept while being attenuated. Thus, even if there is only a little human movement, it is possible to hold a high feature value longer than in the case of using a moving average. This improves the accuracy of detecting a person when there is only a little human movement. For example, the use of the peak hold process enables detecting the presence of a person even if the time during which there is only a little human movement continues for a predetermined period of time or more (e.g., several seconds).

Note that the effect of the previous value can be made to linger for a longer period of time (the previous value is made to have a longer influence) by seeing the value of attenuation coefficient as closer to one. Attenuation coefficient as and rising coefficient af are stored in advance in storage 24.

### Variation 2 of Embodiment 1

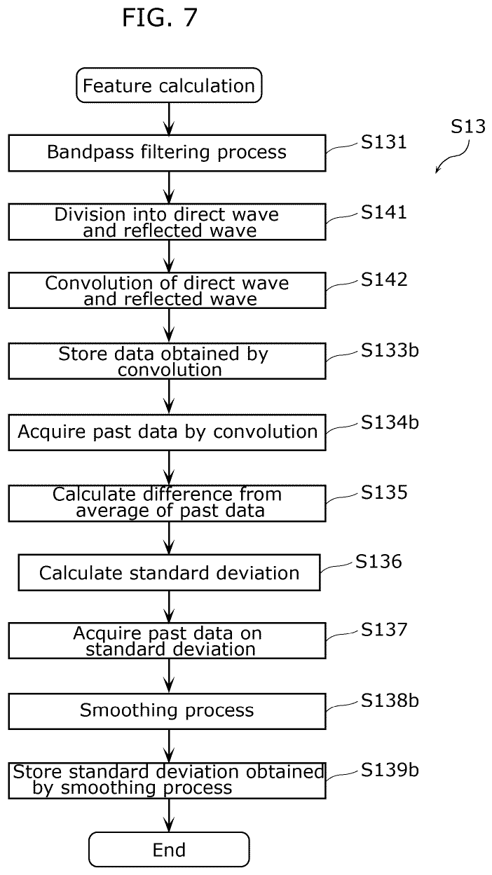

Hereinafter, information processing device 20 according to another variation of the present embodiment is described with reference to FIG. 7.

FIG. 7 is a flowchart corresponding to step S13 shown in FIG. 2 and showing operations of information processing device 20 (information processing method) according to the present variation. The present variation describes information processing device 20 capable of reducing the influence exerted on the calculation of the feature even when the ultrasound emitted from sound emitter 11 is unstable. Specifically, an example is described in which, instead of the reflected wave, a signal generated by convolution of the direct wave and the reflected wave is used to detect the presence or absence of a person. According to the present variation, the direct wave (first direct wave) is also received, in addition to the reflected wave, in step S12 shown in FIG. 2.

As shown in FIG. 7, reflected-wave extractor 22 divides the signal that has undergone the band-pass filtering process into a direct wave and a reflected wave (S141). Since the time to receive the direct wave can be acquired in advance, reflected-wave extractor 22 uses, for example, this time to divide the signal that has undergone the band-pass filtering process into a direct wave and a reflected wave. For example, in the case of the signal shown in (a) in FIG. 4, reflected-wave extractor 22 may divide the signal such that the waveform before 0.0025 s is regarded as the direct wave and the waveform after 0.0025 onward is regarded as the reflected wave.

Then, reflected-wave extractor 22 performs a convolution process on the direct wave and the reflected wave (S142). The convolution process as used herein includes performing a binary operation in which one of the direct wave and the reflected wave is displaced in parallel so as to be overlaid on and added to the other of the direct wave and the reflected wave. The convolution process of the direct wave and the reflected wave corresponds to calculating the impulse responses of the direct wave and the reflected wave.

This allows the extraction of the reflected wave with a strong correlation with the direct wave and thereby reduces the influence of fluctuations of the direct wave that may occur. Examples of the fluctuations of the direct wave include changes in amplitude for each emission. The signal generated by convolution of the direct wave and the reflected wave is one example of a first convolutional signal included in the first signal. Note that reflected-wave extractor 22 may perform the process in a frequency domain. For example, in the case of performing the process in a frequency domain, reflected-wave extractor 22 may process only a specific frequency such as the frequency of the emitted signal. In this case, reflected-wave extractor 22 does not need to include the band-pass filter.

Then, reflected-wave extractor 22 stores the data that has undergone the convolution process (first convolutional signal) in storage 24 (S133b). The stored data serves as past data that has undergone the convolution process and is used the next time when the process shown in FIG. 7 is executed.

Then, average calculator 23 acquires the past data that has undergone the convolution process from storage 24 (S134b) and calculates an average of the past data that has undergone the convolution process. The past data, i.e., the signal that has undergone the convolution process in the past, is one example of a second convolutional signal. The reflected wave and the direct wave acquired at past times during the execution of the process shown in FIG. 7 are one example of a second reflected wave and a second direct wave, and the signal generated by convolution of the second reflected wave and the second direct wave is one example of the second convolutional signal included in the second signal.

Then, difference calculator 25 calculates a difference between the first convolutional signal and the average of the past data (e.g., the second convolutional signal) (S135). In the case where one second convolutional signal (e.g., the latest second convolutional signal) is selected from among a plurality of second convolutional signals, difference calculator 25 may calculate a difference between the first convolutional signal and the one second convolutional signal. Then, difference calculator 25 executes the process in step S136 by using the past data that has undergone the convolution process.

Then, smoothing processor 26 acquires the past data on the standard deviation from storage 24 (S137) and executes the smoothing process on the standard deviation calculated in step S136 and the past data on the standard deviation (S138b). Examples of the smoothing process include a moving average process and a peak hold process, but are not limited thereto. Smoothing processor 26 also stores the standard deviation that has undergone the smoothing process in storage 24 (S139b). The stored standard deviation serves as past data on the standard deviation and is used the next time when the process shown in FIG. 7 is executed. Note that the standard deviation that has undergone the smoothing process is one example of a value based on the standard deviation of the amplitude of the differential signal. In the present variation, the direct wave is also received, in addition to the reflected wave, in step S12 shown in FIG. 2.

### Variation 3 of Embodiment 1

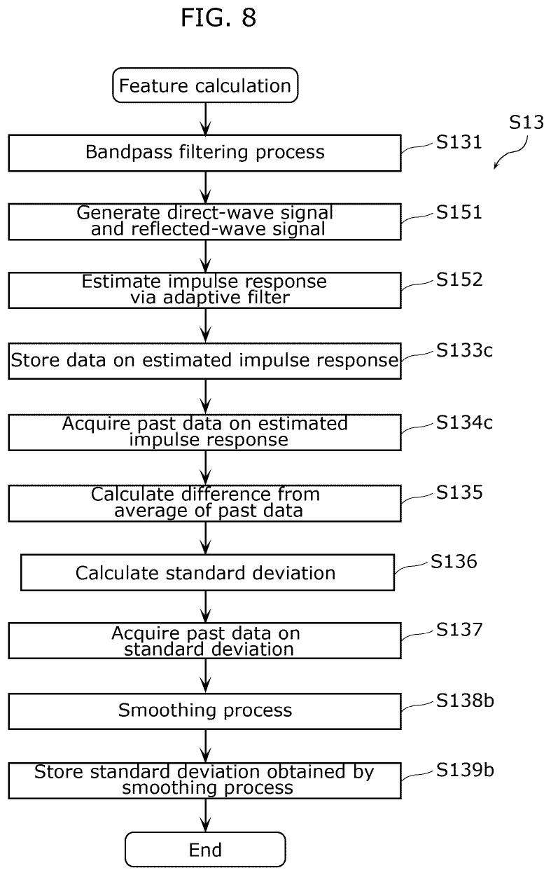

Hereinafter, information processing device 20 according to another variation of the present embodiment is described with reference to FIGS. 8 to 10.

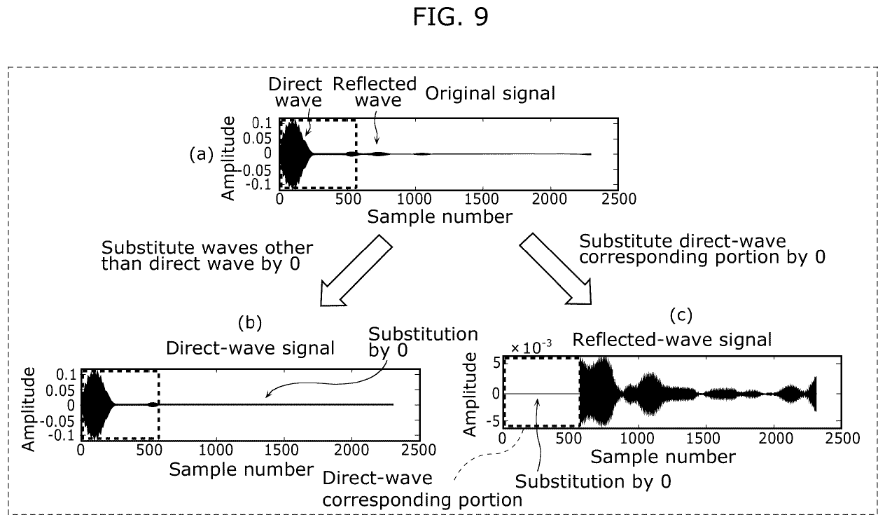

FIG. 8 is a flowchart corresponding to step S13 shown in FIG. 2 and showing operations of information processing device 20 (information processing method) according to the present variation. FIG. 9 is a diagram showing one example of various waveforms according to the present variation. In FIG. 9, the vertical axis indicates amplitude, and the horizontal axis indicates sample number (the number of times sampling is performed). The present variation describes information processing device 20 capable of reducing the possibility that the accuracy of detecting the presence or absence of a person may be deteriorated by fluctuations in feature value caused by changes in the state of a space. Examples of the changes in the state of a space include a change in airflow in the space caused by, for example, turn-on of an air conditioner.

As shown in FIG. 8, reflected-wave extractor 22 generates a direct-wave signal and a reflected-wave signal based on the signal that has undergone the band-pass filtering process (S151).

In FIG. 9, (a) shows the signal (original signal) that has undergone the band-pass filtering process. The original signal includes the direct wave in the broken-line frame and the reflected wave outside the broken-line frame. The broken-line frame represents a direct-wave corresponding area including the direct wave. The reflected wave outside the broken-line frame is the reflected wave corresponding to a target detection range. Note that the sampling frequency of the original signal is two times or more higher than the frequency of emission of the sound source and may, for example, be 96 kHz, but not limited thereto.

As shown in (b) in FIG. 9, reflected-wave extractor 22 generates the direct-wave signal by substituting a portion of the original signal other than a direct-wave portion thereof (e.g., a portion corresponding to the reflected-wave signal) with zero. The substitution with zero is the process of substituting the amplitude value with zero. The direct-wave signal may, for example, be a signal obtained by setting the amplitude of the reflected wave in the received signal including the direct wave and the reflected wave to zero. As shown in (c) in FIG. 9, reflected-wave extractor 22 generates the reflected-wave signal by substituting the direct-wave portion of the original signal with zero. The reflected-wave signal may, for example, be a signal obtained by setting the amplitude of the direct wave (e.g., the direct-wave corresponding area) in the received signal including the direct wave and the reflected wave to zero.

This produces two waveform data items with the same number of samples (with the same time interval).

Referring back to FIG. 8, reflected-wave extractor 22 estimates an impulse response via an adaptive filter for each sample of the direct-wave signal and the reflected-wave signal (S152). Although one impulse response is estimated for one original signal in Variation 2 of Embodiment 1, in the present variation, impulse responses corresponding to the number of samples are estimated for one original signal. The estimated impulse responses are one example of the first impulse response included in the first signal.

Accordingly, the period for calculating the impulse responses can be used as the sampling period. That is, the period of calculating the impulse responses is not limited by the period of emission of the sound source and can be made shorter than the period of emission of the sound source.

Then, reflected-wave extractor 22 stores data on the estimated impulse responses in storage 24 (S133c). The data on the estimated impulse responses serves as past data on the estimated impulse responses and is used the next time when the process shown in FIG. 8 is executed.

Then, average calculator 23 acquires the past data on the estimated impulse responses from storage 24 (S134c) and calculates an average of the past data on the impulse responses. The past data on the impulse responses indicates the impulse responses acquired at past times before the first impulse response, and is one example of the second impulse response included in the second signal.

Then, difference calculator 25 calculates a difference between the estimated impulse responses and the average of the past data (S135).

A standard deviation calculated by processing including the above-described process is calculated at shorter time intervals than the period of emission of the sound source. For example, in the case where there is a change in the state of a space such as air being blown in the space, the period of calculating the standard deviation is short and, accordingly, the amplitude of the differential signal becomes smaller than in the case of calculating the differential signal at the period of emission of the sound source. This reduces the possibility that the feature will be calculated larger than its intrinsic value due to a change in the state of the space, thereby avoiding misjudgment of the result of detecting the presence or absence of a person. That is, it is possible to improve trackability to slight changes in the state of the space and to improve robustness against disturbances.

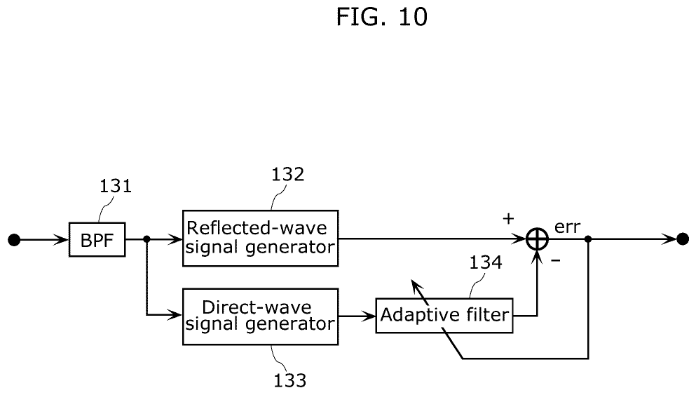

Here, a functional configuration for estimating an impulse response for each one sample is described with reference to FIG. 10. FIG. 10 is a block diagram showing a functional configuration for estimating impulse responses via adaptive filter 134 according to the present variation. For example, each constituent element shown in FIG. 10 may be included in reflected-wave extractor 22.

As shown in FIG. 10, reflected-wave extractor 22 (see FIG. 1) includes band-pass filter 131 (BPF in FIG. 10), reflected-wave signal generator 132, direct-wave signal generator 133, and adaptive filter 134.

Band-pass filter 131 is a filter for performing the band-pass filtering process in step S131.

Reflected-wave signal generator 132 is a processing unit that generates a reflected-wave signal by substituting the direct-wave portion of the original signal with zero.

Direct-wave signal generator 133 is a processing unit that generates a direct-wave signal by substituting the portion of the original signal other than the direct-wave portion (e.g., the portion corresponding to the reflected-wave signal) with zero.

In the case of using adaptive filter 134, signals need to be at the same time (zero is the same timing) and have the same sampling period and the same signal length. The reflected-wave signal generated by reflected-wave signal generator 132 and the direct-wave signal generated by direct-wave signal generator 133 are signals that satisfy this condition.

Adaptive filter 134 is a filter that self-adapts its transfer function in accordance with a predetermined algorithm (e.g., an optimization algorithm). In the example shown in FIG. 10, adaptive filter 134 is updated such that the signal obtained by convolution of the direct-wave signal and the impulse response of adaptive filter 134 and the direct-wave signal matches the reflected-wave signal. If the two signals do not match, for example, an error is detected and adaptive filter 134 is updated. Note that the impulse response is obtained by inverse Fourier transform of the transfer function.

Note that the sampling interval for the impulse response to be estimated may be arbitrarily set in consideration of, for example, the amount of computation. That is, the impulse response does not need to be estimated for all of a plurality of samples included in the received signal.

### Variation 4 of Embodiment 1

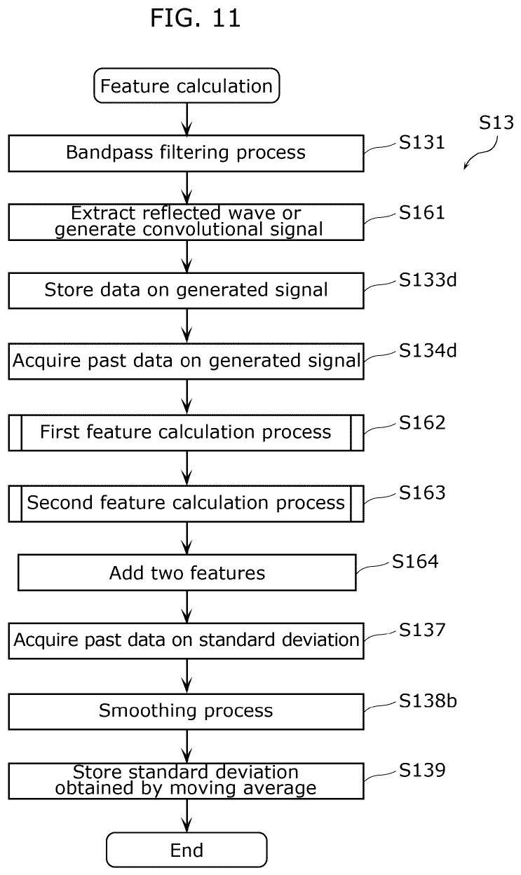

Hereinafter, information processing device 20 according to another variation of the present embodiment is described with reference to FIGS. 11 to 14. The present variation describes an example in which a change over time in the reflected wave or the amplitude shape of the convolutional signal is added to the feature. FIG. 11 is a flowchart corresponding to step S13 shown in FIG. 2 and showing operations of information processing device 20 (information processing method) according to the present variation.

As shown in FIG. 11, reflected-wave extractor 22 extracts a reflected wave from the signal that has undergone the band-pass filtering process or generates a convolutional signal by convolution of the direct wave and the reflected wave (S161), and stores data on the generated signal in storage 24 (S133d). The stored data serves as past data on the signal and is used the next time when the process shown in FIG. 11 is executed. Hereinafter, an example is described in which the reflected wave is extracted in step S161.

Then, average calculator 23 acquires the past data on the generated signal (here, the past data on the reflected wave) from storage 24 (S134d) and calculates an average of the past data on the generated signal.

Then, difference calculator 25 executes a first feature calculation process (S162) and a second feature calculation process (S163).

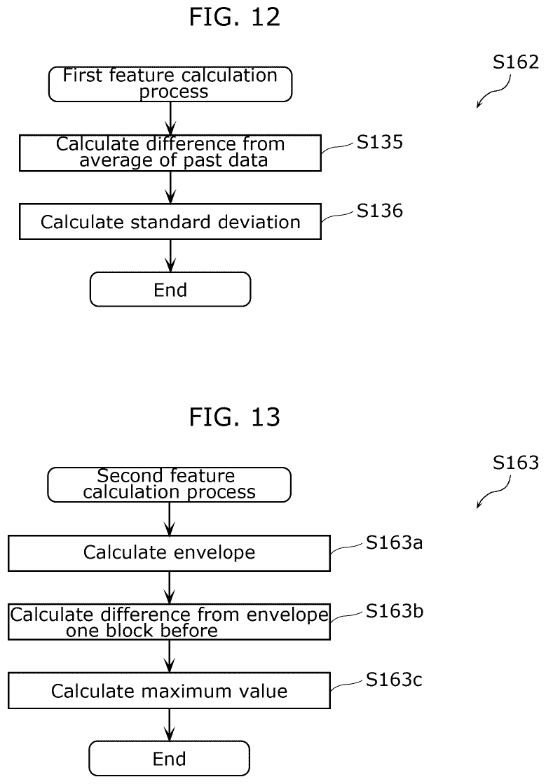

FIG. 12 is a flowchart showing detailed operations (information processing method) performed in step S162 shown in FIG. 11.

As shown in FIG. 12, in the first feature calculation process, processing in steps S135 and S136 described in Embodiment 1 or the like is executed.

FIG. 13 is a flowchart showing detailed operations (information processing method) performed in step S163 shown in FIG. 11.

As shown in FIG. 13, in the second feature calculation process, difference calculator 25 firstly calculates an envelope of the reflected wave extracted in step S161 (S163a). The envelope is a line that connects each maximum value of the amplitude of the reflected wave. By using the envelope, only the amplitude of the reflected wave is focused on, so that it is possible to eliminate the influence of a phase shift of the reflected wave caused by disturbances such as airflow. Note that the envelope calculated in step S163a is one example of a first envelope signal. The envelope is also a signal that indicates a change over time in the amplitude of the reflected wave and is included in the first signal.

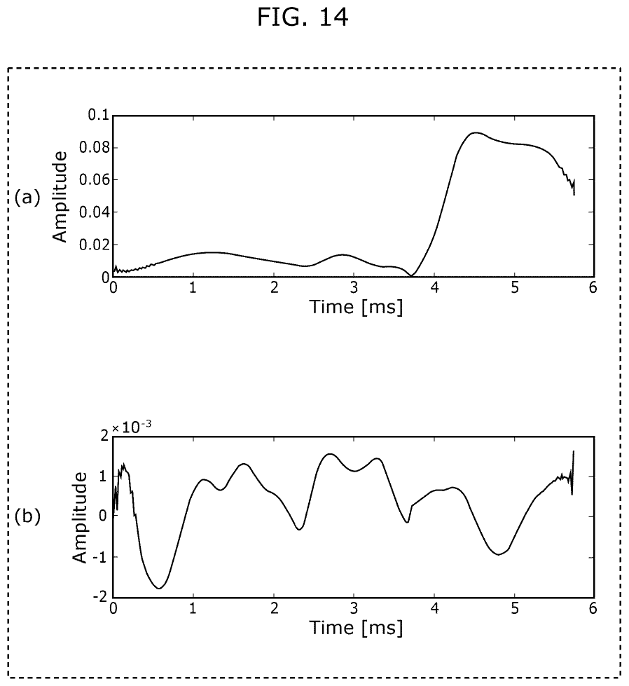

FIG. 14 is a diagram showing one example of various waveforms according to the present variation. In FIG. 14, (a) shows an envelope that connects each maximum value on the plus side of the amplitude of the reflected wave shown in (b) in FIG. 14. For example, difference calculator 25 calculates the envelope as shown in (a) in FIG. 14.

Referring back to FIG. 13, difference calculator 25 then calculates a difference from the envelope one block before (S163b). That is, difference calculator 25 calculates a difference between the past envelope and the envelope calculated in step S163a. For example, a differential signal as shown in (b) in FIG. 14 is calculated. Note that the past envelope is one example of a second envelope signal. The past envelope is a signal that indicates a change over time in the amplitude of the second reflected wave and is included in the second signal, the second reflected wave being acquired at a past time before the first reflected wave.

Then, difference calculator 25 calculates a maximum value of the differential signal (S163c). Difference calculator 25 calculates a maximum value of the amplitude of the differential signal shown in (b) in FIG. 14. The maximum value of the amplitude is, for example, a maximum value of the absolute value of the difference (amplitude) in the time-axis direction. Here, the maximum value is a scalar value. The maximum value, i.e., the feature, may be a dimensionless quantity.

Referring back to FIG. 11, smoothing processor 26 then adds two features (S164). Here, smoothing processor 26 adds the maximum value and the standard deviation Note that smoothing processor 26 may perform weighed addition of the maximum value and the standard deviation, or may calculate one scalar value from the maximum value and the standard deviation by any operation other than addition (e.g., at least one of subtraction, multiplication, and division).

In this way, information (envelope) that indicates a change over time in the amplitude shape of the reflected wave may be added to the feature. For example, the presence or absence of a person may be detected by using the two features. Taking into account a change in amplitude shape over time brings about the advantage of easily grasping a change in the reflected waveform accompanying the movement of the reflector. By using the information indicating a change over time in the amplitude shape of the reflected wave and using the two features, it is possible to improve robustness against fluctuations in the amplitude of the reflected wave accompanying refraction of the sound wave caused by airflow.

Although the above variation describes an example in which the feature for use in determining the presence or absence of a person is calculated by adding two features, the feature for use in determining the presence or absence of a person may be calculated by, for example, adding three or more features or any other operation.

Note that information processing device 20 may determine the presence or absence of a person by using only the maximum value of the envelope out of the maximum values of the standard deviation and the envelope.

### Variation 5 of Embodiment 1

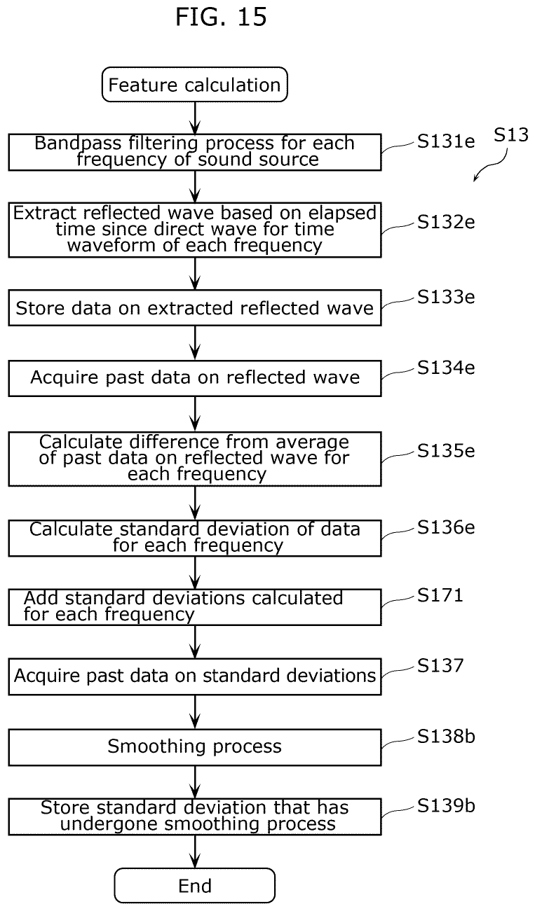

Hereinafter, information processing device 20 according to another variation of the present embodiment is described with reference to FIG. 15. The present variation describes a case of using burst waves of a plurality of frequencies. FIG. 15 is a flowchart corresponding to step S13 shown in FIG. 2 and showing operations of information processing device 20 (information processing method) according to the present variation. There are no particular limitations on the plurality of frequencies, but the frequencies may, for example, be 20 kHz, 30 kHz, and 40 kHz. There are also no particular limitations on the number of frequencies as long as two or more frequencies are used.

As shown in FIG. 15, information processing device 20 executes processing in steps S131 to S136 shown in FIG. 3 for each frequency of the sound source (each frequency of the burst waves) in steps S131e to 136e. That is, processing in steps S131e to S136e is performed on the reflected wave for each frequency of the sound source. For example, a reflected wave with the value of the frequency of the sound source is extracted in step S132e, a difference for the value of the frequency of the sound source is calculated in step S135e, and a standard deviation of the value of the frequency of the sound source is calculated in step S136e.

Then, smoothing processor 26 adds the standard deviations calculated for each frequency (S171). Smoothing processor 26 may perform weighed addition of the standard deviations, or may calculate one scalar value from the standard deviations by using any operation other than addition (e.g., at least one of subtraction, multiplication, and division).

In this way, information processing device 20 may use the burst waves of a plurality of frequencies of the sound source to calculate one feature (feature for use in determining the presence or absence) by calculating and adding features (e.g., standard deviations) obtained for each frequency. This reduces the influence of noise of a specific frequency or noise accompanying environmental changes such as temperature, humidity, or airflow on the determination of the presence or absence of a person.

In the present variation, sound emitter 11 may emit the burst waves of a plurality of frequencies at the same time, or may emit these burst waves at different times.

### Embodiment 2

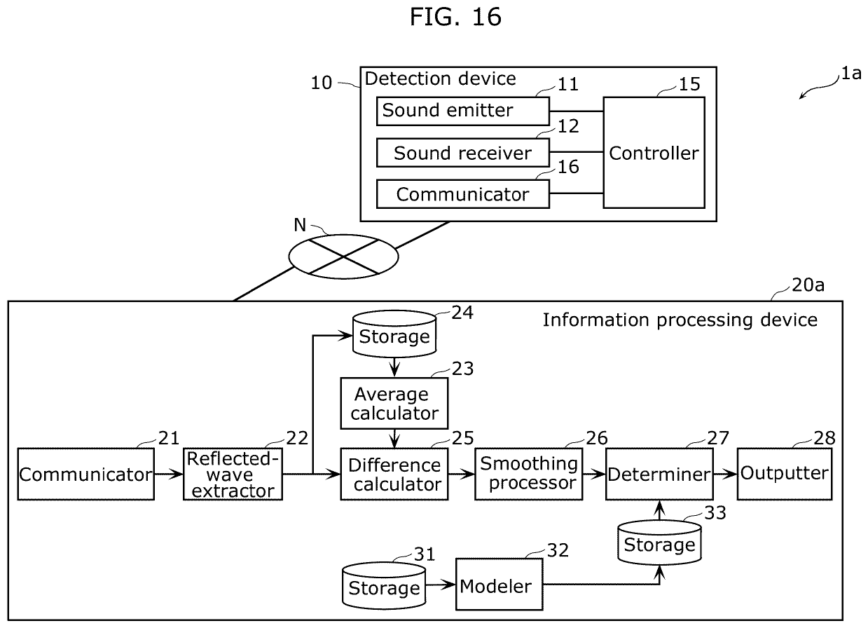

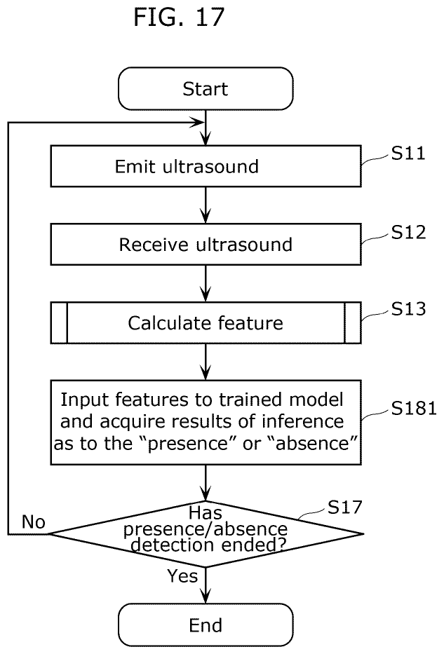

Hereinafter, an information processing system according to the present embodiment is described with reference to FIGS. 16 and 17. The following description mainly focuses on differences from Embodiment 1, and descriptions of contents that are identical or similar to those of Embodiment 1 may be omitted or simplified.

### 2-1. Configuration of Information Processing System

First, a configuration of the information processing device according to the present embodiment is described with reference to FIG. 16. FIG. 16 is a block diagram showing a functional configuration of information processing system 1a according to the present embodiment. The present embodiment describes an example in which the presence of a person is detected using a machine learning model that receives input of a feature and outputs the result of detection of the presence or absence of a person.

As shown in FIG. 16, information processing device 20a includes storages 31 and 33 and modeler 32 in addition to information processing device 20 according to Embodiment 1. Determiner 27 determines the presence or absence of a person by using a machine learning model created by modeler 32.

Storage 31 stores learning data that is used by modeler 32 to train the machine learning model. The learning data includes a plurality of sets of a feature serving as input data and supervised data indicating the presence or absence of a person at that time. Here, the feature is one standard deviation, but may be any data such as time-series data on standard deviations or waveform data on the differential signal. That is, the machine learning model to be created may be any of a model that receives input of one standard deviation (i.e., one scalar value) as input information, a model that receives input of time-series data on standard deviations (e.g., time-series data on standard deviations for two seconds), and a model that receives input of the waveform data on the differential signal itself. Storage 31 may be realized as semiconductor memory or the like, but is not limited thereto.

Modeler 32 creates the machine learning model by training using the learning data. More specifically, modeler 32 creates the machine learning model by supervised training using the learning data. The created machine learning model (trained model) receives input of the feature and outputs the result of inference of the presence or absence of a person. Modeler 32 also stores the created trained model in storage 33.

Modeler 32 includes a computer including, for example, memory and a processor (microprocessor) and realizes various functions by causing the processor to execute control programs stored in the memory.

Storage 33 stores the trained model created by modeler 32. For example, storage 33 may be realized as semiconductor memory or the like, but is not limited thereto.

Determiner 27 reads the trained model from storage 33 and acquires the output (the result of inference) of the trained model obtained by inputting the feature to the read trained model, as the result of determining the presence or absence of a person.

Note that storage 31 and modeler 32 may be realized by a device separated from information processing device 20a. A learning device may be configured to include storage 31 and modeler 32, and may be communicably connected to information processing device 20a.

In the case where the waveform data on the differential signal itself is input as the feature to the machine learning model, information processing device 20a does not need to include smoothing processor 26.

### 2-2. Operations of Information Processing System

Next, operations of information processing system 1a configured as described above is described with reference to FIG. 17. FIG. 17 is a flowchart showing operations of information processing system 1a (information processing method) according to the present embodiment.

As shown in FIG. 17, after the feature is calculated (S13), determiner 27 inputs the feature to the trained model and acquires the result of inference of the “presence” or “absence” (S181). Determiner 27 acquires the output of the “presence” or “absence” obtained by inputting the feature to the trained model, as the result of determining the presence or absence of a person.

This allows the system to determine the presence or absence of a person by using the machine learning model.

In the present embodiment, modeler 32 executes the process of creating the machine learning model as pre-processing performed before the execution of the operations shown in FIG. 17. The method of creating the machine learning model via modeler 32 includes acquiring a plurality of features and a plurality of determination results as to the presence or absence of a person, and training the machine learning model by using the acquired features as input information and the acquired determination results as correct data.

### OTHER EMBODIMENTS

While the information processing method and so on according to one or a plurality of aspects have been described with reference to Embodiment 1, Variations 1 to 5 of Embodiment 1, and Embodiment 2 (embodiments or the like), the present disclosure is not limited to those embodiments or the like. The present disclosure may also include other modes obtained by making various modifications conceivable by those skilled in the art to the embodiments of the present disclosure, or modes constructed by any combinations of constituent elements according to different embodiments without departing from the scope of the present disclosure.

For example, although Embodiment 1 and Variation 2 of Embodiment 1 describe that at least one of the processing units including the reflected-wave extractor, the average calculator, the difference calculator, and the smoothing processor may perform processing in a frequency domain, the other processing units in the embodiments or the like may process only a specific frequency such as the frequency of the emitted signal when processing is performed in a frequency domain. In this case, the reflected-wave extractor does not need to include the band-pass filter.

In the embodiments or the like described above, each of the constituent elements may be configured in the form of an exclusive hardware product, or may be realized by executing a software program suitable for the constituent element. Each of the constituent elements may be realized by means of a program executing unit such as a CPU or a processor, reading and executing a software program recorded on a recording medium such as a hard disk or semiconductor memory.

The sequence of the steps executed in each flowchart is merely one example in order to specifically describe the present disclosure, and may be any sequence other than that described above. Some of the steps described above may be executed simultaneously (in parallel) with other steps, or some of the steps described above may not be executed.

The way of dividing the functional blocks in each block diagram is merely one example. A plurality of functional blocks may be realized as one functional block, one functional block may be divided into a plurality of functional blocks, or some functions may be transferred to a different functional block. The functions of a plurality of functional blocks having similar functions may be processed in parallel or in time sequence by single hardware or software.

The information processing device according to the embodiments or the like described above may be realized as a single device, or may be realized as a plurality of devices. In the case where the information processing device is realized as a plurality of devices, each of the constituent elements included in the information processing device may be allocated in any way to the plurality of devices. In the case where the information processing device is realized as a plurality of devices, there are no particular limitations on the communication method used between the devices, and the communication method may be either wireless communication or cable communication. Alternatively, wireless communication and cable communication may be used in combination between the devices. The information processing device according to the embodiments or the like described above may also be realized as a cloud server.

The detection device and the information processing device according to the embodiments or the like described above are not limited to separate devices, and may be realized as a single device. In the case where those devices are realized as a single device, the information indicating the first reflected wave may be a signal that includes the reflected wave received by the sound receiver, and the sound receiver may function as an acquirer that directly acquires that information (acquires by means of sensing). Alternatively, the detection device may include some of the functions of the information processing device.

Each of the constituent elements described in the embodiments or the like described above may be realized by software, or typically, may be realized by LSI serving as an integrated circuit. These constituent elements may be individually formed into a single chip, or some or all of the constituent elements may be included and formed into a single chip. Although the LSI is described here as one example, the LSI may be referred to as an IC, a system LSI, a super LSI, or an ultra LSI depending on the degree of integration. The method for circuit integration is not limited to the LSI, and may be realized as an exclusive circuit (general-purpose circuit for executing an exclusive program) or a general-purpose processor. After the manufacture of the LSI, it is also possible to use a field programmable gate array (FPGA) capable of programming or a reconfigurable processor capable of reconfiguring connections or settings of circuit cells inside the LSI. Moreover, if any other circuit integration technology that replaces the LSI makes its debut with the advance of semiconductor technology or other derivative technology, such technology may of course be used for the integration of the constituent elements.

The system LSI is a super-multi-functional LSI manufactured by integrating a plurality of processing units on a single chip, and is specifically a computer system configured to include, for example, a microprocessor, read only memory (ROM), and random access memory (RAM). The ROM stores computer programs. The system LSI achieves its functions as a result of the microprocessor operating in accordance with the computer programs.

One aspect of the present disclosure may be a computer program that causes a computer to execute each characteristic step included in the information processing method shown in any of FIGS. 2, 3, 5, 7, 8, 11 to 13, 15, and 17.

For example, the program may be a program to be executed by the computer. Another aspect of the present disclosure may be a non-transitory computer-readable recording medium that has such a program recorded thereon. For example, such a program may be recorded on a recording medium for circulation or distribution. For example, a distributed program may be installed in a device including a different processor, and the processor may be caused to execute the program in order to allow the device to perform each process described above.

### INDUSTRIAL APPLICABILITY

The present disclosure is applicable to an information processing device or the like for detecting the presence or absence of a person in a sound speech system or the like.

1. An information processing method that is executed by a computer, the information processing method comprising:
acquiring information indicating a first reflected wave acquired by emitting ultrasound into a space;
calculating a feature based on a difference between a first signal and a second signal, the first signal being based on the first reflected wave, the second signal being based on information indicating a second reflected wave acquired at a past time before the first reflected wave; and
determining whether a person is present or absent in the space in accordance with the feature calculated.

2. The information processing method according to claim 1,
wherein the first signal includes the first reflected wave,
the second signal includes the second reflected wave, and
the feature is a value based on a first standard deviation of an amplitude of a differential signal between the first reflected wave and the second reflected wave.

3. The information processing method according to claim 1, further comprising:
acquiring a first direct wave of the ultrasound,
wherein the first signal includes a first convolutional signal obtained by convolution of the first reflected wave and the first direct wave,
the second signal includes a second convolutional signal obtained by convolution of a second direct wave and the second reflected wave acquired at a past time before the first reflected wave, and
the feature is a value based on a first standard deviation of an amplitude of a differential signal between the first convolutional signal and the second convolutional signal.

4. The information processing method according to claim 1, further comprising:
acquiring a direct wave of the ultrasound;
generating a direct-wave signal and a reflected-wave signal, the direct-wave signal being generated by substituting an amplitude of the first reflected wave in a received signal with zero, the reflected-wave signal being generated by substituting an amplitude of the direct wave in the received signal with zero, the received signal including the direct wave and the first reflected wave; and
estimating a first impulse response via an adaptive filter in accordance with the direct-wave signal and the reflected-wave signal,
wherein the first signal includes the first impulse response, and
the second signal includes a second impulse response acquired at a past time before the first impulse response.

5. The information processing method according to claim 1,
wherein the first signal includes a signal that indicates a change over time in an amplitude of the first reflected wave, and
the second signal includes a signal that indicates a change over time in an amplitude of the second reflected wave, the second reflected wave being acquired at a past time before the first reflected wave.

6. The information processing method according to claim 2,
wherein the first signal includes a first envelope signal that indicates a change over time in an amplitude of the first reflected wave,
the second signal includes a second envelope signal that indicates a change over time in an amplitude of the second reflected wave, the second reflected wave being acquired at a past time before the first reflected wave, and
the feature is a value calculated by computing a value based on the first standard deviation and a maximum value of an amplitude of a differential signal between the first envelope signal and the second envelope signal.

7. The information processing method according to claim 1,
wherein the second reflected wave has an average waveform of reflected waves received at a plurality of past times.

8. The information processing method according to claim 2, further comprising:
acquiring one or more second standard deviations calculated at one or more past times before the first standard deviation,
wherein the feature is a value obtained by a smoothing process performed on the first standard deviation and the one or more second standard deviations.

9. The information processing method according to claim 8,
wherein the smoothing process includes a moving average process.

10. The information processing method according to claim 8,
wherein the smoothing process includes a peak hold process for storing a maximum value of the one or more second standard deviations acquired during a predetermined period of time, and
the feature is a value based on the first standard deviation and the maximum value stored in the peak hold process.

11. The information processing method according to claim 1,
wherein the ultrasound is emitted periodically.

12. The information processing method according to claim 1,
wherein the ultrasound includes a burst wave.

13. The information processing method according to claim 12,
wherein the burst wave includes a plurality of frequency components.

14. The information processing method according to claim 1,
wherein the ultrasound includes a chirp signal.

15. The information processing method according to claim 1,
wherein a person is determined to be present in the space when the feature is greater than or equal to a predetermined value, and
a person is determined to be absent in the space when the feature is less than the predetermined value.

16. The information processing method according to claim 1, further comprising:
acquiring, by inputting the feature to a machine learning model, a result of inference as to whether a person is present or absent in the space.

17. The information processing method according to claim 16, further comprising:
acquiring a plurality of features and a plurality of determination results as to whether a person is present or absent; and
training the machine learning model by using the plurality of features acquired as input information and using the plurality of determination results as correct data.

18. An information processing device comprising:
an acquirer that acquires information indicating a first reflected wave of ultrasound, the first reflected wave being acquired by emitting the ultrasound into a space;
a calculator that calculates a feature based on a difference between a first signal and a second signal, the first signal being based on the first reflected wave, the second signal being based on information indicating a second reflected wave acquired at a past time before the first reflected wave; and
a determiner that determines, based on the feature calculated, whether a person is present or absent in the space.

19. A non-transitory computer-readable recording medium having recorded thereon a program for causing a computer to execute the information processing method according to claim 1.
